(19) United States
(12) Patent Application Publication
(10) Pub. No.: US 2003/0076396 A1
(43) Pub. Date: Apr. 24, 2003

(54) Cutter device for a printer

(76) Inventor: Saburou Imai, Chiba-shi (JP)

Correspondence Address: ADAMS & WILKS, 31st Floor, 50 Broadway, New York, NY, 10004, US

(21) Appl. No.: 10/245,407

(22) Filed: Sep. 17, 2002

(30) Foreign Application Priority Data
Oct. 18, 2001 (JP) 2001-320666 JAPAN

(51) Int. Cl. B41J 2/01

(52) U.S. Cl. 347/101

(57) ABSTRACT

To provide a cutter device for a printer in which it is possible, in a printing state in which a movable blade is on standby for movement, to reduce a flicking noise generated between gears and to restrain vibrations generated. A cutter drive mechanism (20) is equipped with a one-way clutch mechanism (40) composed of a driving gear (27) connected to a driving means and a driven gear (28) in mesh with the driving gear, the driven gear having in a part of its outer peripheral portion (101) where teeth (G2) are formed a cutout portion (102) corresponding to a predetermined number of teeth; the tooth surface of a trigger gear member (T) equipped with teeth (G3) in a number less than that corresponding to the cutout portion faces the cutout portion; an arm portion (A) is arranged which supports the tooth surface while urging it clockwise; an urging means (torsion spring S) for imparting clockwise urging force is provided on the arm portion of the trigger gear member, and there is provided a rotation regulating means (K) for regulating counterclockwise rotation of the driven gear itself with the movable blade being at rest at the home position; the driving gear also engages with the tooth surface of the trigger gear member when rotating counterclockwise to transmit driving force to the driven gear; when it rotates clockwise, it causes the teeth of the trigger gear member to retreat against the urging force so as to flick the teeth counterclockwise to thereby prevent transmission of driving force to the driven gear regulated in counterclockwise rotation by the rotation regulating means.

### BACKGROUND OF THE INVENTION

1. Field of the Invention

The present invention relates to a cutter device for a printer for cutting paper after printing.

2. Description of the Related Art

A thermal printer, which is a kind of printer, has come to be widely used as the output device of a facsimile machine, the output device of a POS system, or the like; in many cases, a roll of heat-sensitive paper is used as the recording paper.

Some of these printers using a roll of paper are equipped with a cutter device for automatically cutting the recording paper after printing, into an appropriate length.

Generally speaking, the cutter device is equipped with a stationary blade and a movable blade, and the movable blade is driven with a predetermined timing by using a dedicated drive source or a printer drive source to cut the recording paper after printing.

Roughly speaking, the movable blade is of two types: a type in which a round blade rolls along the stationary blade in a direction perpendicular to the recording paper conveying direction; and a so-called guillotine type in which a plate-like blade with a clearance angle at the end moves toward and away from the stationary blade.

FIG. 6 shows an example of the guillotine type cutter device. FIG. 6 is an exploded perspective view showing an example of the construction of a conventional guillotine type cutter device C2.

As shown in FIG. 6, there are provided five gears arranged on an upper plate 136 of a head support plate 116: a gear (driving gear) 127, and driven gears 128, 129, 130, and 131, and axles 127a, 128a, 129a, 130a, and 131a for rotatably mounting these gears to the upper plate 136. These gears 127, 128, 129, 130, and 131 are arranged two-dimensionally along the upper plate 136 arranged parallel to the paper feeding direction X. Reference numeral 113 indicates a platen roller for conveying the recording paper (not shown) in the X-direction.

In a cutter drive mechanism 120, power transmitted through a bevel gear 126 is transmitted successively by way of the gear (driving gear) 127 and the driven gears 128, 129, 130, and 131. The construction of the cutter drive mechanism 120 is such that the gears 128 and 131 move in synchronism with a gear ratio of one-to-one; at positions off the rotation centers of the gears 128 and 131, there protrude downwards drive pins 128b and 131b for driving the movable blade 112, causing a slide plate 117 to slide in the paper feeding direction X. The slide plate 117 has two guide grooves 117a and 117b in the form of elongated round holes extending in the direction perpendicular to the paper feeding direction X; at the time of assembly, the drive pins 128b and 131b are inserted into these guide grooves 117a and 117b under the upper plate 136 fixed to the upper surface of the support plate 116 (on the thermal head side) so as to allow moving (sliding) in the paper feeding direction X with the cutter drive mechanism 120 therebetween. Thus, when the gears 127 through 131 rotate, the drive pins 128b and 131b rotate, and, with this rotation, the slide plate 117 reciprocates in a direction parallel to the paper feeding direction X. As a result, the movable blade 112 fixed to the slide plate 117 reciprocates between the home position H and the cutting position C. In FIG. 7, the movable blade 112 is at the home position H, and in FIG. 8, it is at the cutting position C.

FIG. 9 shows the construction of the cutter drive mechanism 120.

As shown in FIG. 9, on the gear 128 of the cutter drive mechanism 120, there is formed a clutch portion 141 with a part of its teeth cut away; further, due to an engagement pin 145 provided at a position off the rotation center, the gear 128 is pressurized by a torsion spring 139 in a predetermined direction, which, in this example, is counterclockwise as seen from above the cutter drive mechanism 120.

The gear (driven gear) 128 and the gear (driving gear) 127 form a one-revolution (single-revolution) clutch mechanism 140; in the condition in which the clutch portion 141 is in contact with the gear 127, the gear 128 is pressurized counterclockwise by a force F2, so that, if the gear 127 rotates counterclockwise, there is no gear meshing, and no power is transmitted.

When the gear 127 rotates clockwise, it is engaged with the gear 128, and power is transmitted. And when the gear 127 rotates clockwise and the gear 128 makes one revolution, the movable blade 112 makes one reciprocation between the home position H and the cutting position C. Thereafter, when the gear 127 rotates counterclockwise, the clutch 141 is restored, while in contact with the gear 127, to the angle at which it is pressurized by the spring 139.

Thus, the angle of the gear 128 when printing is being performed through counterclockwise rotation of the gear 127 is always kept at a fixed level, and, during printing, the movable blade 112 is set at the home position H without fail.

By using the one-revolution mechanism 140 thus constructed, it is possible to reliably maintain the movable blade 112 at the home position without using any optical sensor or limit switch, making it advantageously possible to provide a cutter device C2 of a simple construction and high positional accuracy.

In the one-revolution clutch mechanism 140 provided in the cutter drive mechanism 120 of the cutter device C2 shown in FIGS. 6 through 9, when the gear 127 rotates counterclockwise, it idles with its teeth flicking clockwise the edge portion of the cutout portion 141 of the gear 128, so that no power is transmitted to the gear 128, and the cutter device is placed in the printable state in which the movable blade 112 is kept on standby at the home position H. The torsion spring 139 which engages in this state with the engagement pin 145 of the gear 128 to impart an urging force in the direction F2 is relatively large, and its resilient force is strong, so that there is a great crackling noise when the gear 128 is flicked, which constitutes a noise factor in the printer operation.

Further, the vibration when the gear 128 is flicked is relatively great, and the vibration generated between the gear (driving gear) 127 and the gear (driven gear) 128 during printing may be transmitted to the entire printer through the other driven gears 129, 130, 131, etc., thereby adversely affecting the printing quality.

### SUMMARY OF THE INVENTION

This invention has been made with a view to solving the above-mentioned problems in the prior art. It is an object of this invention to provide a cutter device for a printer in which in a printing state in which a movable blade is on standby for movement, it is possible to reduce a flicking noise generated between gears and to restrain vibrations generated thereby.

In order to achieve the above-mentioned object, according to the present invention, there is provided a cutter device for a printer equipped with a movable blade (17) and a stationary blade (300) for cutting at a predetermined position recording paper which has undergone printing by a printing means, the cutter device including:

a cutter drive mechanism (20) for causing the movable blade to advance and retreat with respect to the stationary blade,

the cutter drive mechanism being equipped with a rotation mechanism which causes, through one rotation of a driven gear (28) connected to the movable blade, the movable blade to make one reciprocation between a home position (H) spaced apart from the stationary blade by a predetermined distance and a cutting position (c) where it cuts the recording paper through cooperation with the stationary blade,

the rotation mechanism being connected to a one-way clutch mechanism (40) connected to a driving means capable of normal and reverse rotation and adapted to rotate a platen roller (13) in the paper feeding direction when the driving means makes normal rotation and to drive the movable blade of the cutter when the driving means makes reverse rotation,

the one-way clutch mechanism being composed of a driving gear (27) connected to the driving means and a driven gear (28) in mesh with the driving gear,

the driven gear having in a part of its outer peripheral portion (101) where teeth (G2) are formed a cutout portion (102) corresponding to a predetermined number of teeth,

the tooth surface of a trigger gear member (T) that is equipped with teeth (G3) in a number less than that corresponding to the cutout portion facing the cutout portion with arranging an arm portion (A) supporting the tooth surface while urging it clockwise,

an urging means (torsion spring S) imparting a clockwise urging force being arranged on the arm portion of the trigger gear member,

the driven gear being equipped with a rotation regulating means (K) for regulating counterclockwise rotation of the driven gear itself with the movable blade being at rest at the home position,

the driving gear being also engaged with the tooth surface of the trigger gear member to transmit driving force to the driven gear when it rotates counterclockwise and causing the teeth of the trigger gear member to retreat against the urging force so as to flick them counterclockwise when it rotates clockwise so as not to transmit driving force to the driven gear regulated in counterclockwise rotation by the rotation regulating means.

In this way, the driven gear is equipped with members such as a relatively small trigger gear member and an urging means, so that it is possible to reduce the size of the one-way clutch mechanism as compared with the prior art; since the urging force of the trigger gear member is small, it is possible, during execution of printing and paper feeding, to reduce the noise made when the driving gear rotates clockwise to flick the teeth of the trigger gear member as compared with the prior art.

Further, since it is also possible to reduce the vibration when the driving gear rotates clockwise to flick the teeth of the trigger gear member, it is possible to avoid a situation in which vibration generated in the one-way clutch mechanism is transmitted to the components of the printer to adversely affect the printing quality.

Since it is accommodated inside a hollow portion formed in the inner periphery of the driven gear, it is possible to further reduce the size of the one-way clutch mechanism.

Further, it is possible for the arm portion of the trigger gear member to be rotatably supported at a position off the rotation axis of the driven gear, whereby it is possible to realize, with a simple construction, a counterclockwise retreating movement of the trigger gear member when the driving gear rotates clockwise.

Further, the arm portion of the trigger gear member is formed of a flexible material; when the driving gear rotates clockwise, the arm itself undergoes counterclockwise deformation, making it possible to cancel its engagement with the teeth of the driving gear. Thus, when the driving gear rotates clockwise, it is possible to aid the counterclockwise retreating movement of the trigger gear member, and to absorb the vibration when the driving gear rotates clockwise to flick the teeth of the trigger gear member, thereby restraining the vibration and reducing the noise generated.

Further, the rotation regulating means is composed of a protrusion formed on the bottom surface of the driven gear and having a vertical surface and an inclined surface, a vertical portion arranged in the vicinity of the rotation axis of the driven gear and adapted to engage with the vertical surface of the protrusion in the state in which the movable blade is at rest at the home position to regulate the counterclockwise rotation of the driven gear, and a rotation regulating member equipped with an arm portion adapted to be displaced along the inclined surface of the protrusion when the driven gear is rotated clockwise. Thus, it is possible, with a simple construction, to regulate the counterclockwise rotation of the driven gear itself in the state in which the movable blade is at rest at the home position.

### BRIEF DESCRIPTION OF THE DRAWINGS

For a more better understanding of the present invention, reference is made of a detailed description to be read in conjunction with the accompanying drawings, in which:

FIG. 1 is a plan view showing a construction of a cutter device for a printer according to this embodiment;

FIG. 2 is an exploded perspective view showing the construction of the cutter device for a printer according to this embodiment;

FIG. 3 is an explanatory drawing showing an operation of a one-way clutch mechanism constituting a main portion of the cutter device for a printer of this embodiment;

FIG. 4 is a sectional view showing a construction example of a driven-gear-rotation regulating means constituting a main portion of the cutter device for a printer of this embodiment;

FIG. 5 is an explanatory drawing showing states of the rotation regulating means;

FIG. 6 is an exploded perspective view showing a construction of a conventional cutter device for a printer;

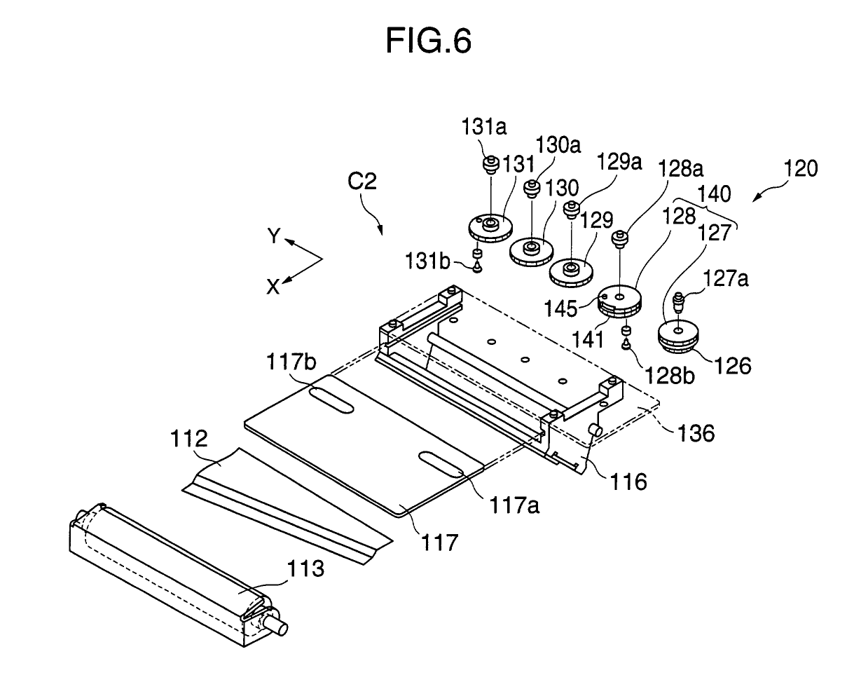

FIG. 7 is an explanatory drawing showing a home position H of a movable blade of the cutter device for a printer;

FIG. 8 is an explanatory drawing showing a cutting position C of the movable blade of the cutter device for a printer; and

FIG. 9 is a plan view showing the construction of the cutter drive mechanism of a conventional cutter device for a printer.

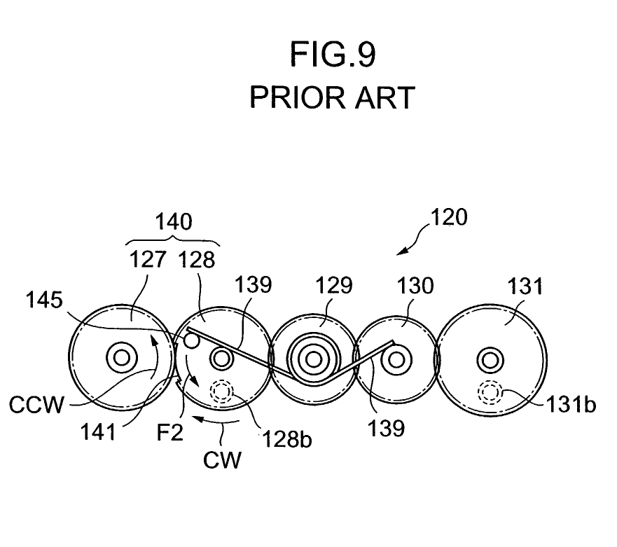

### DETAILED DESCRIPTION OF THE PREFERED EMBODIMENT

A preferred embodiment of the present invention will now be described with reference to the drawings.

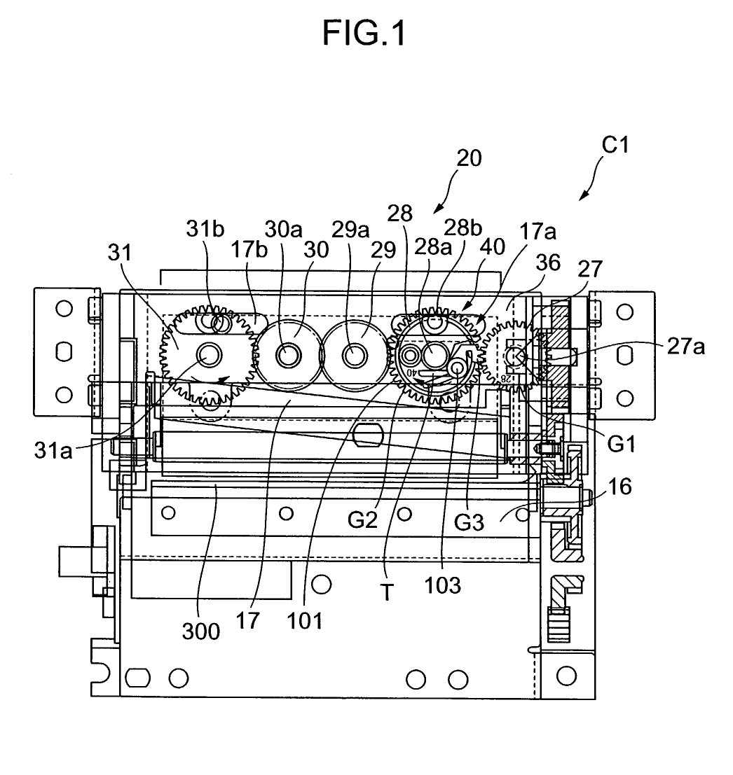

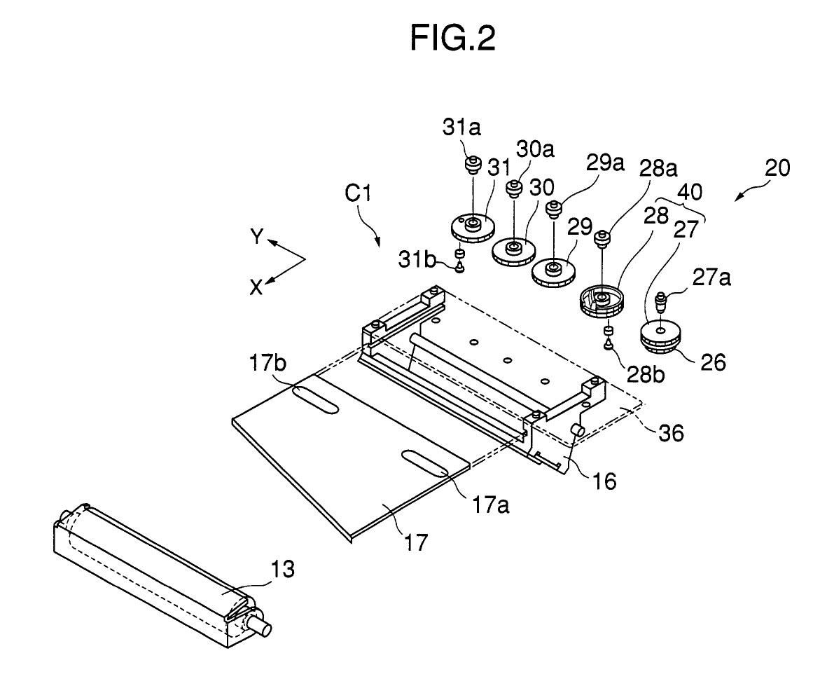

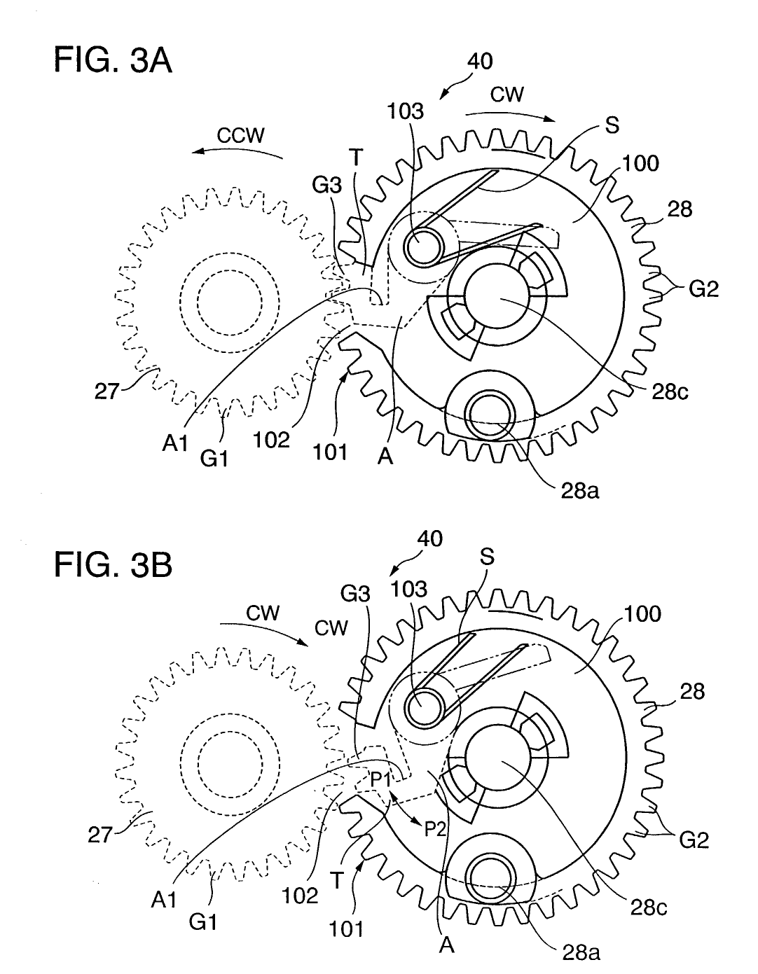

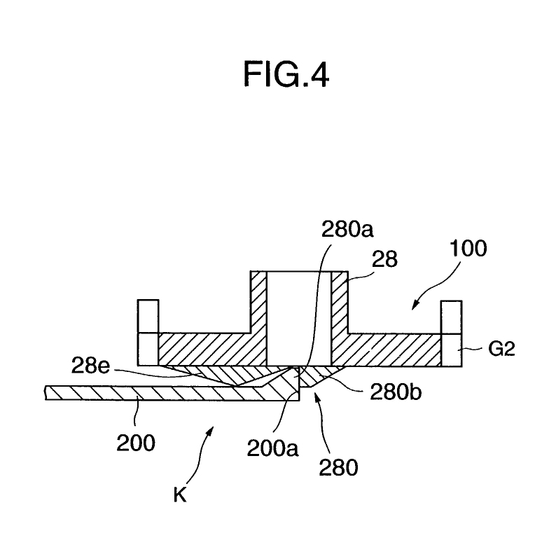

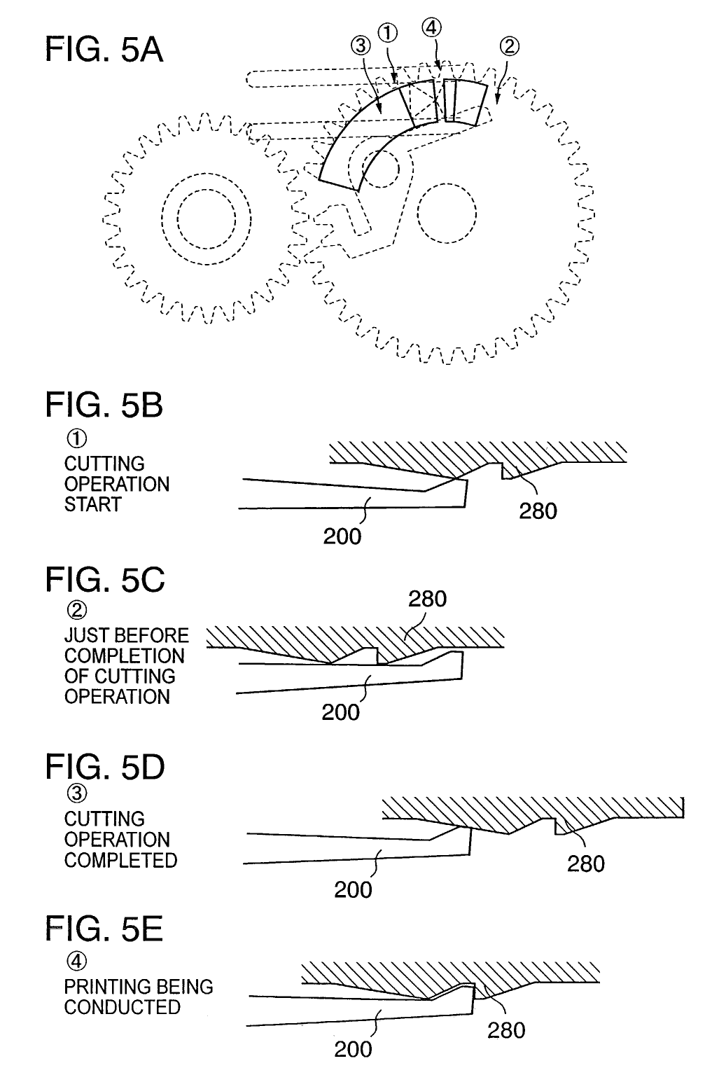

FIG. 1 is a plan view showing a construction of a cutter device for a printer according to this embodiment; FIG. 2 is an exploded perspective view thereof; FIG. 3 is an explanatory diagram illustrating the operation of a one-way clutch mechanism constituting a main portion of the cutter device; FIG. 4 is a sectional view showing a construction example of a driven-gear-rotation regulating means constituting a main portion of the cutter device; and FIG. 5 is an explanatory drawing showing the states of the rotation regulating means.

As shown in FIGS. 1 and 2, a cutter device C1 for a printer according to this embodiment is equipped with five gears: a gear (driving gear) 27 and driven gears 28, 29, 30, and 31 arranged on an upper plate 36 of a head support plate 16, and axles 27a, 28a, 29a, 30a, and 31a for rotatably mounting the gears to the upper plate 36.

These gears 27, 28, 29, 30, and 31 are arranged two-dimensionally along the upper plate 36 arranged parallel to the paper feeding direction X. In FIG. 2, reference numeral 13 indicates a platen roller for conveying recording paper (not shown) in the X-direction.

In the cutter drive mechanism 20 of the cutter device C1, power transmitted through a bevel gear 26 (See FIG. 2) is transmitted successively through the gear (driving gear) 27 and the driven gears 28, 29, 30, and 31. The cutter drive mechanism 20 is constructed with a gear arrangement such that the gears 28 and 31 move in synchronism at a gear ratio of one-to-one; at positions off the rotation centers of the gears 28 and 31, there protrude upwards drive pins 28b and 31b for causing a plate-like movable blade 17 to slide in the paper feeding direction X.

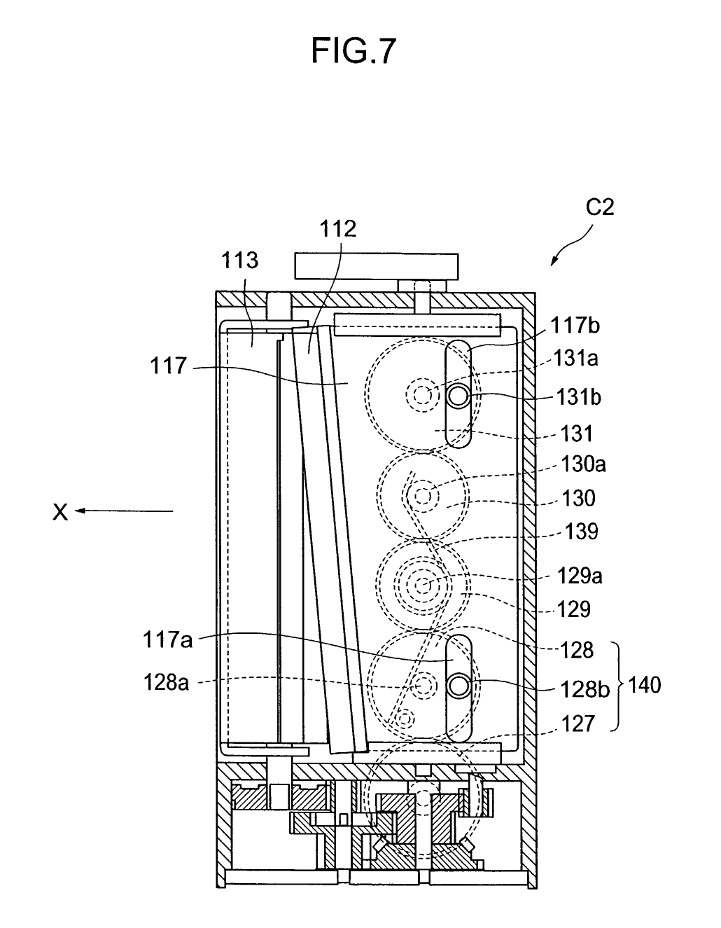

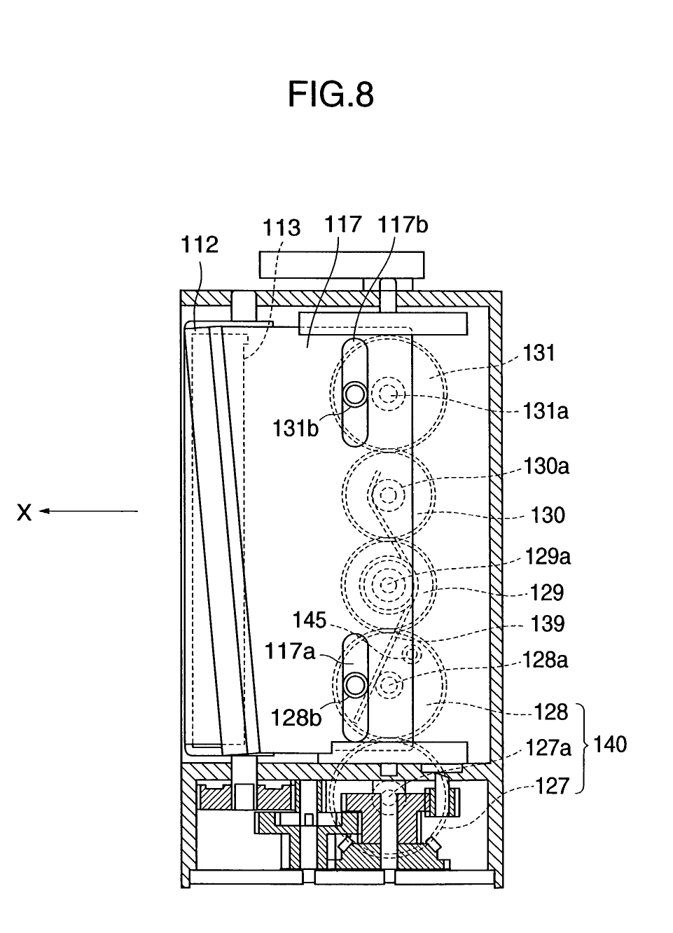

Also, the movable blade 17 has two guide grooves 17a and 17b in the form of elongated round holes extending in the Y-direction, which is perpendicular to the paper feeding direction X; at the time of assembly, the drive pins 28b and 31b are inserted into these guide grooves 17a and 17b under the upper plate 36 fixed to the upper surface of the support plate 16 (on the thermal head side) so as to allow moving (sliding) in the paper feeding direction X with the cutter drive mechanism 20 placed therebetween. Thus, when the gears 27 through 31 rotate, the drive pins 28b and 31b rotate, and, with this rotation, the movable blade 17 reciprocates in a direction parallel to the paper feeding direction X. As a result, the movable blade 17 reciprocates between a home position H and a cutting position C (See FIGS. 7 and 8 for the positional relationship between the home position H and the cutting position C as described above).

Note that, a stationary blade 300 is perpendicular to the direction in which the movable blade 17 advances and retreats and is arranged at a position where it can cooperate with the edge of the movable blade 17 to cut the recording paper (not shown).

As shown in FIG. 3, a one-way clutch mechanism 40 of the cutter drive mechanism 20 is composed of a driving gear 27 and a driven gear 28.

The driven gear 28 has a hollow portion 100 in its inner periphery, and, in a portion of the outer peripheral portion 101 where a large number of teeth G2 are formed, a cutout portion 102 corresponding to a predetermined number of teeth and communicating with the hollow portion 100; a trigger gear member T having teeth G3 in a number less than the number of teeth corresponding to the cutout portion 102 (two in this embodiment) is arranged such that the surface of the teeth G3 faces the cutout portion 102; an arm portion A is accommodated in the hollow portion 100 so as to support the teeth G3 while urging them clockwise.

The arm portion of the trigger gear member T is rotatably supported by a rotation axis 103 arranged off the rotation axis 28c of the driven gear 28.

Further, the trigger gear member T is formed of flexible plastic or the like. At the forward end of the arm portion A of the trigger gear member T, a U-shaped bent portion A1 is formed so that counterclockwise force can easily escape. Due to this arrangement, it is possible to aid the counterclockwise retreating movement of the trigger gear member T when the driving gear 27 rotates clockwise. Further, it is possible to absorb the vibration when the driving gear 27 rotates clockwise to flick the teeth G3 of the trigger gear member T to thereby restrain the vibration and to reduce the noise generated.

Further, arranged inside the hollow portion 100 of the driven gear 28 is a torsion spring S fitted onto a rotation axis 103 and serving as an urging means for imparting a clockwise urging force to the arm portion A of the trigger gear member T.

Further, the driven gear 28 is provided with a rotation regulating means K for regulating counterclockwise rotation of the driven gear 28 itself in the state in which the movable blade 17 is at rest at the home position H.

As shown in FIG. 4, in this embodiment, the rotation regulating means K is composed of a protrusion 280 formed on the bottom surface of the driven gear 28 and having a vertical surface 280a and an inclined surface 280b, a vertical portion 200a arranged in the vicinity of the rotation axis 28c of the driven gear 28 on the upper plate 36 and adapted to engage with the vertical surface 280a of the protrusion 280 in the state in which the movable blade 17 is at rest at the home position H to regulate the counterclockwise rotation of the driven gear 28, and an arm-like rotation regulating member 200 adapted to be displaced along the inclined surface 280b of the protrusion 280 when the driven gear 28 is rotated clockwise.

The rotation regulating means K is constructed such that at the start of cutting operation (state (1) of FIG. 5(a)), just before the completion of cutting operation (state (2) of FIG. 5(a)) and at the time of completion of cutting operation (state (3) of FIG. 5(a)), the arm-like rotation regulating member 200 and the protrusion 280 of the driven gear 28 are in a non-engaged state, as shown in FIGS. 5(b) through 5(d), thus maintaining a state in which the driven gear 28 can rotate.

On the other hand, during printing (state (4) of FIG. 5(a)), the arm-like rotation regulating member 200 and the protrusion 280 of the driven gear 28 are in an engaged state as shown in FIG. 5(e), whereby rotation of the driven gear 28 is regulated.

Thus, it is possible to regulate, with a simple construction, counterclockwise rotation of the driven gear 28 itself in the state in which the movable blade 17 is at rest at the home position H (the printable state).

In the cutter device C1, constructed as described above, when the driving gear 27 rotates counterclockwise, it engages with, in addition to the teeth G2 in the outer peripheral portion of the driven gear 28, the teeth G3 of the trigger gear member T, as shown in FIG. 3(a), and transmits driving force to the driven gear 28 to cause the movable blade 17 to make one reciprocation between the home position H and the cutting position C; when the driving gear 27 rotates clockwise, the teeth G3 of the trigger gear member T are caused to retreat against the urging force so as to flick the teeth counterclockwise (swung between points P1 and P2 of FIG. 3(b)), as shown in FIG. 3(b) so that no driving force may be transmitted to the driven gear 28, which is regulated in counterclockwise rotation by the rotation regulating means K, whereby it is possible to perform printing on the recording paper.

Then, in accordance with this embodiment, the hollow portion 100 of the driven gear 28 contains members, such as the trigger gear member T and the torsion spring S serving as the urging means, so that it is possible to reduce the size of the one-way clutch mechanism 40 as compared with the prior art; since the urging force of the trigger gear member T is small, it is possible to reduce the noise generated when the driving gear 27 rotates clockwise to flick the teeth G3 of the trigger gear member T during execution of printing and during paper feeding as compared with the prior art.

Further, it is also possible to reduce the vibration generated when the driving gear 27 rotates clockwise to flick the teeth of the trigger gear member, so that it is possible to prevent the vibration generated in the one-way clutch mechanism 40 from being transmitted to the printer components to adversely affect the printing quality.

It goes without saying that regarding other devices, modifications are possible as appropriate without departing from the technical scope of the present invention.

For example, while in this embodiment the one-way clutch mechanism 40 is accommodated in the hollow portion 100 of the driven gear 28, this should not be construed restrictively. It may also be possible to arrange it on the front or back side of the driven gear.

As described above, in accordance with the present invention, the driven gear is equipped with members, such as a relatively small trigger gear member and an urging means, so that it is possible to reduce the size of the one-way clutch mechanism itself as compared with the prior art; since the urging force of the trigger gear member is small, it is possible to reduce the noise generated when the driving gear rotates clockwise to flick the teeth of the trigger gear member during execution of printing and during paper feeding as compared with the prior art.

Further, it is also possible to reduce the vibration when the driving gear rotates clockwise to flick the teeth of the trigger gear member, so that it is possible to prevent the vibration generated in the one-way clutch mechanism from being transmitted to the printer components to adversely affect the printing quality.

What is claimed is:

1. A cutter device for a printer equipped with a movable blade and a stationary blade for cutting at a predetermined position recording paper which has undergone printing by a printing means, the cutter device comprising:
a cutter drive mechanism for causing the movable blade to advance and retreat with respect to the stationary blade,
the cutter drive mechanism being equipped with a rotation mechanism which causes, through one rotation of a driven gear connected to the movable blade, the movable blade to make one reciprocation between a home position spaced apart from the stationary blade by a predetermined distance and a cutting position where it cuts the recording paper through cooperation with the stationary blade,
the rotation mechanism being connected to a one-way clutch mechanism connected to a driving means capable of normal and reverse rotation and adapted to rotate a platen roller in the paper feeding direction when the driving means makes normal rotation and to drive the movable blade of the cutter when the driving means makes reverse rotation,
the one-way clutch mechanism being composed of a driving gear connected to the driving means and a driven gear in mesh with the driving gear,
the driven gear having in a part of its outer peripheral portion where teeth are formed a cutout portion corresponding to a predetermined number of teeth,
the tooth surface of a trigger gear member equipped with teeth in a number less than that corresponding to the cutout portion facing the cutout portion with arranging an arm portion supporting the tooth surface while urging it clockwise,
an urging means imparting a clockwise urging force being arranged on the arm portion of the trigger gear member,
the movable blade being equipped with a rotation regulating means for regulating counterclockwise rotation of the driven gear itself with the movable blade being at rest at the home position,
the driving gear being also engaged with the tooth surface of the trigger gear member to transmit driving force to the driven gear when it rotates counterclockwise and causing the teeth of the trigger gear member to retreat against the urging force so as to flick them counterclockwise when it rotates clockwise so as not to transmit driving force to the driven gear regulated in counterclockwise rotation by said rotation regulating means.

2. A cutter device for a printer according to claim 1, wherein the trigger gear member is accommodated inside a hollow portion formed in the inner periphery of the driven gear.

3. A cutter device for a printer according to claim 1, wherein the arm portion of the trigger gear member is rotatably supported at a position off the rotation axis of the driven gear.

4. A cutter device for a printer according to claim 1, wherein the arm portion of the trigger gear member is formed of a flexible material; when the driving gear rotates clockwise, the arm undergoes counterclockwise deformation, making it possible to cancel its engagement with the teeth of the driving gear.

5. A cutter device for a printer according to claim 4, wherein the rotation regulating means comprises
a protrusion formed on the bottom surface of the driven gear and having a vertical surface and an inclined surface;
a vertical portion placed in the vicinity of the rotation axis of the driven gear and adapted to engage with the vertical surface of the protrusion in the state in which the movable blade is at rest at the home position to regulate the counterclockwise rotation of the driven gear; and
a rotation regulating member equipped with an arm portion adapted to be displaced along the inclined surface of the protrusion when the driven gear is rotated clockwise.

6. A cutter device for a printer according to claim 3, wherein the rotation regulating means comprises
a protrusion formed on the bottom surface of the driven gear and having a vertical surface and an inclined surface;
a vertical portion placed in the vicinity of the rotation axis of the driven gear and adapted to engage with the vertical surface of the protrusion in the state in which the movable blade is at rest at the home position to regulate the counterclockwise rotation of the driven gear; and
a rotation regulating member equipped with an arm portion adapted to be displaced along the inclined surface of the protrusion when the driven gear is rotated clockwise.

7. A cutter device for a printer according to claim 2, wherein the rotation regulating means comprises
a protrusion formed on the bottom surface of the driven gear and having a vertical surface and an inclined surface;
a vertical portion placed in the vicinity of the rotation axis of the driven gear and adapted to engage with the vertical surface of the protrusion in the state in which the movable blade is at rest at the home position to regulate the counterclockwise rotation of the driven gear; and
a rotation regulating member equipped with an arm portion adapted to be displaced along the inclined surface of the protrusion when the driven gear is rotated clockwise.

8. A cutter device for a printer according to claim 1, wherein the rotation regulating means comprises
a protrusion formed on the bottom surface of the driven gear and having a vertical surface and an inclined surface;
a vertical portion placed in the vicinity of the rotation axis of the driven gear and adapted to engage with the vertical surface of the protrusion in the state in which the movable blade is at rest at the home position to regulate the counterclockwise rotation of the driven gear; and
a rotation regulating member equipped with an arm portion adapted to be displaced along the inclined surface of the protrusion when the driven gear is rotated clockwise.
